(19) United States
(12) Patent Application Publication
(10) Pub. No.: US 2007/0046780 A1
(43) Pub. Date: Mar. 1, 2007

(54) Remote intercom operator with finder

(76) Inventor: Anthony Johnston, North Hollywood, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/212,797

(22) Filed: Aug. 25, 2005

(51) Int. Cl. H04N 7/18

(52) U.S. Cl. 348/152

(57) ABSTRACT

A retaining-locking system for chain link fence slats includes specially notched fence slat elements having a pointed upper or lower end. The slat elements are sized and shaped to be interwoven between consecutive links of a chain link fence. A retaining-locking strip is formed of resilient material, and has an inner surface and an outer surface and at least one securing protrusion. The securing protrusion is sized and shaped to fit slidably within the notch. The protrusion is located on the outer surface of the strip. When the slat elements are interwoven into between consecutive links of a chain link fence with each of the notches aligned with one another, the retaining-locking strip inserted between the slat elements and the links, with the securing protrusion disposed within the slats, the strip will urge the slats toward the links, thereby retaining the slats within the chain link fence.

### FIELD OF INVENTION

The invention pertains to remote control systems systems. More particularly, the invention relates to remote operational controls for home security and access systems.

### BACKGROUND OF THE INVENTION

As home security becomes a serious concern for many homeowners, more and more homes and apartments are equipped with security systems for controlling entry through building doors. This is typically done in conjunction with an intercom system incorporating an electrically controlled door lock at a remote location. In use, the person desiring entry will actuate a doorbell or buzzer which rings inside of the home or apartment of the occupant. The occupant will then use the intercom system to enquire who is at their door. Upon receiving a satisfactory answer, the occupant will activate the remote door lock to allow the person entry. These systems generally work very well, however, they present certain problems for those with physical handicaps. It is often difficult for such handicapped person to get to the intercom/remote entry controls in a timely manner after hearing the doorbell or buzzer sound. Likewise, such controls are often mounted too high on a wall for a person in a wheelchair to reach easily. Various solutions have been developed to address these and related problems and some of these are discussed below.

U.S. Patent Application Publication No. 2005/0071879, by Haldavnekar et al., is directed to a method for controlling appliances that can include the step of presenting at least one appliance option for a controlled appliance upon a mobile communications device having mobile telephony capabilities. At least one appliance message can be transmitted across the wireless communications link between a smart space control unit and the mobile communications device. In one arrangement, wireless communication link can be a mobile telephony link. At least one appliance signal can be conveyed between the smart space control unit and the controlled appliance.

U.S. Pat. No. 5,345,226, issued to Rice, Jr. et al., is directed to an environmental control system for the handicapped provides a user interface which is totally integrated and programmable. An audible nested control option selection structure organizes logically related tasks and subtasks together so the user can access the tasks and subtasks in a natural fashion—providing an easy to learn user interface that is user friendly, minimizes frustration in accomplishing desired tasks, and also minimizes the time required to perform even complex control operations. Enhanced user interface features, including time encoding of control switch functions and synthesized speech prompting, further increases ease of operation and functionality. Interaction between different control channels allows the user to perform different tasks simultaneously. Enhanced telephone line manipulation is provided, including off-line assembly of telephone numbers for dialing which can be stored and easily accessed by the user through the unified audible sub-menu structure. Sharing of common hardware for multiple functions minimizes system cost, increases reliability and makes the system easier to use.

U.S. Patent Application Publication No. 2004/0267385, by Lingemann is directed to a building automation system including user interface units with touchscreens, power drivers, and a controller, all connected to a common trunk conductor. The power drivers are connected to the electrical devices and AC wiring. The building automation system further includes wireless remote controls that are connected to the trunk either through a user interface unit or a wireless transceiver. Any electrical device in the building may be controlled by any of the user interface units and wireless remote controls.

U.S. Patent Application Publication No. 2003/0190026, by Lemchen et al. is directed to a network-based intercom system and method comprises software and the necessary portions of a computer network on which it is implemented. The software includes a dispatcher module to be installed on any of the computers of the network, and an intercom module to be installed on each of the participating computers in the system. The system has the advantage that it can be installed on non-dedicated computers, thus avoiding costly and inconvenient wiring and hardware installation.

The system provides automatic message receipt without unnecessarily interrupting a recipient. This is achieved by signaling that a message has been sent by an assigned audible tone that is unique to the addressee. Thus, the recipient becomes aware that he or she has automatically received a message. The message is displayed in a banner on the addressee's computer monitor for selective viewing based on an order of priority. A recipient can respond directly to a message by interfacing with a visual display associated with the message.

U.S. Pat. No. 4,427,847, issued to Hofmann et al. is directed to a television receiver comprising a television system energized by the powerlines of a commercial power grid, a telephone network access system including a microphone disposed in close proximity with the audio speaker of the television system and a remote control system enabling the receiver to be operated in a television mode or a telephone mode. The television receiver according to the invention is characterized by having an annunciator/intercom enabled for operation by the remote control system.

In the annunciator mode, the audio section of the television system is disabled and the microphone is connected through a radio-frequency signal transmitter to the power lines for generating a radio-frequency signal for local transmission. A frequency-modulator is included for modulating the radio frequency signal. At least one remotely located radio-frequency receiver coupled to the power lines is provided for receiving and demodulating the radio-frequency signal and rendering audible television receiver user voice signals. The television receiver user can therefore announce a telephone caller when the television receiver is operated in the annunciator mode. Alternately, intercom units may be employed to provide a two-way intercom conversation link between the television receiver user and a remotely located called party.

It is an objective of the present invention to provide an intercom system with remote door lock opening capability that can be operated from a hand-held remote control. It is a further objective to provide a means for rapidly locating this remote control should it be misplaced. It is yet a further objective to provide both audio and visual means for locating a misplaced remote control. Finally, it is an objective to provide a video image of a visitor visible through the hand-held remote.

While some of the objectives of the present invention are disclosed in the prior art, none of the inventions found include all of the requirements identified.

### SUMMARY OF THE INVENTION

(1) A remote intercom operator with finder having all of the desired features, can be constructed from the following components. An entryway mounted transceiver is provided. The transceiver includes a first microphone, a first speaker, a doorbell switch and an electrical door lock operator. A remote transceiver is provided. The remote transceiver includes a second microphone, a second speaker and a door lock switch. The doorbell switch provides a signal to the remote transceiver and causes a sound to be produced by the second speaker. The remote transceiver provides two-way verbal communication with the entryway mounted transceiver. The door lock switch operates the electrical door lock operator from a remote location.

A remote finder is provided. The remote finder has a first portion and a second portion. The first portion is attached to the remote transceiver, has a signal receiver and a notification device. The second portion has a signal generator. The signal generator is operable by a user from a location remote from the remote transceiver. The signal receiver activates the notification device upon receiving a signal from the signal generator. When the user operates the signal generator, the notification device will inform the user of a location of the remote transceiver.

(2) In a variant of the invention, the entryway mounted transceiver and the remote transceiver communicate via radio frequency signals.

(3) In another variant, the first portion of the remote finder responds to acoustical signals and the second portion of the remote finder produces the acoustical signals.

(4) In still another variant, the acoustical signals produced by the second portion of the remote finder are selected from the group consisting of whistles, bells, buzzers, clicking devices and chimes.

(5) In yet another variant, the first portion of the remote finder responds to infrared signals and the second portion of the remote finder produces the infrared signals.

(6) In a further variant, the first portion of the remote finder responds to radio frequency signals and the second portion of the remote finder produces the radio frequency signals.

(7) In still a further variant, the notification device of the first portion of the remote finder produces an auditory signal.

(8) In another variant of the invention, the notification device of the first portion of the remote finder produces a visual signal.

(9) In still another variant, a video camera is provided. The video camera is positioned adjacent an entranceway controlled by the entryway mounted transceiver. A video monitor is provided. The monitor is attached to the remote transceiver. The video monitor receives video signals from the video camera, thereby permitting the user to view a person seeking entrance at the entranceway.

(10) In yet another variant, the video camera is activated by a switch on the remote transceiver.

(11) In a further variant, the video camera is activated by the doorbell switch on the entryway mounted transceiver.

(12) In still a further variant, a video screen mounted adjacent the entryway mounted transceiver is provided. A video camera is mounted to the remote transceiver. The video camera transmits video images visible from the remote transceiver. When the remote transceiver is pointed at a user, the user and a visitor will have visual communication.

(13) In a final variant of the invention, a switch for the video camera positioned adjacent the entryway mounted transceiver is provided.

### DESCRIPTION OF THE DRAWINGS

FIG. 1 is a schematic view of the preferred embodiment of the invention illustrating the entryway mounted transceiver, the remote transceiver and the two-part finder;

FIG. 2 is a detailed schematic of the FIG. 1 embodiment illustrating the flow of signals between the components;

FIG. 3 is a detailed schematic illustrating the components of the remote finder;

FIG. 4 is a schematic of an enhanced system providing video viewing of the entranceway of a building; and

FIG. 5 is a schematic illustrating two way video communication.

### DETAILED DESCRIPTION OF THE PREFERRED EMBODIMENT

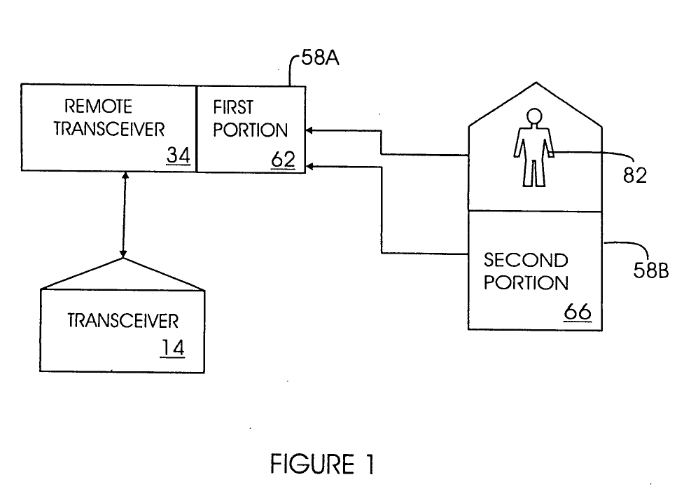

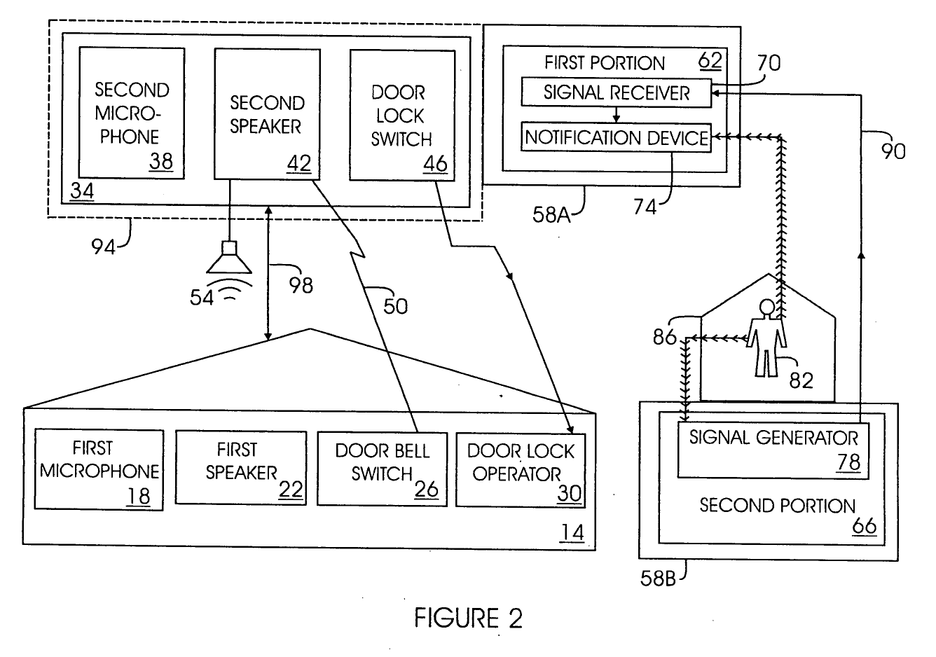

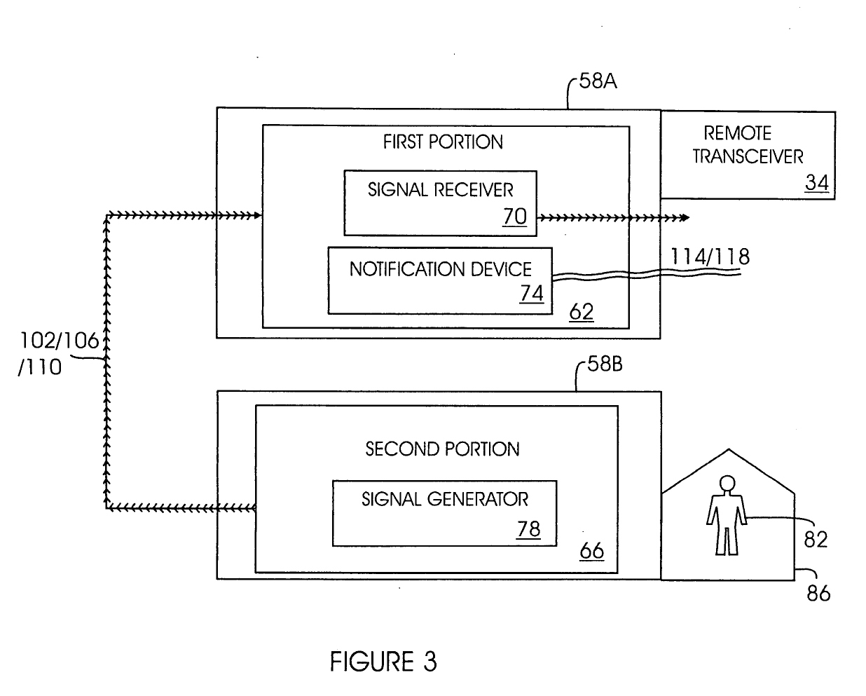

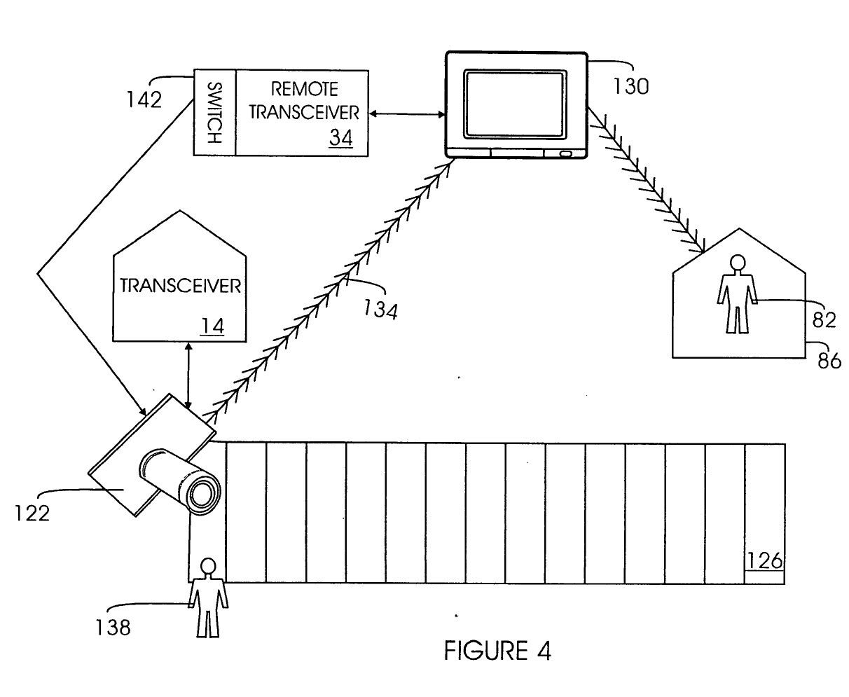

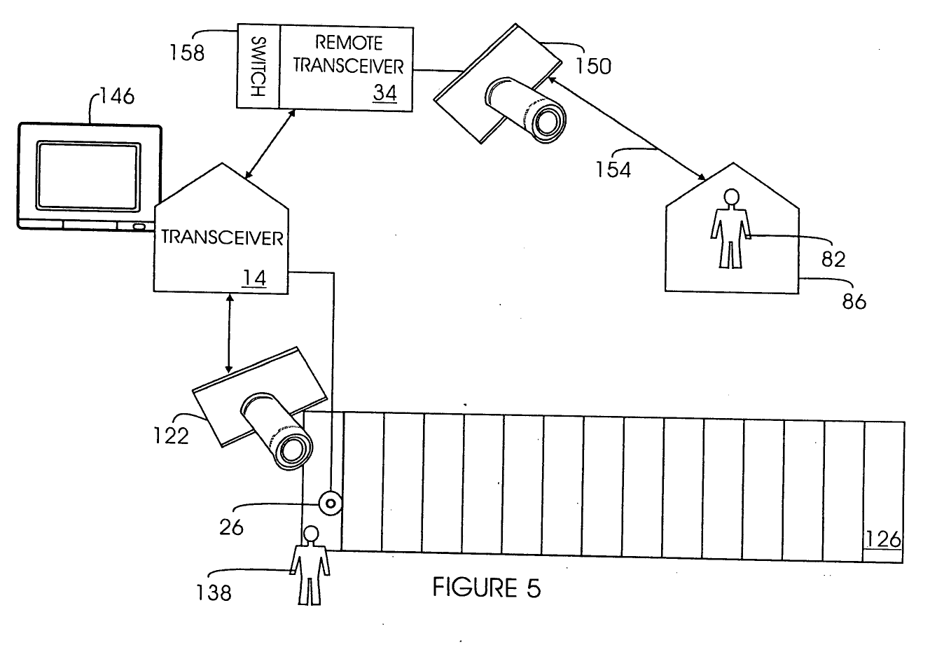

(1) FIGS. 1-5 illustrate a remote intercom operator with finder 10 having all of the desired features that can be constructed from the following components. An entryway mounted transceiver 14 is provided. The transceiver 14 includes a first microphone 18, a first speaker 22, a doorbell switch 26 and an electrical door lock operator 30. A remote transceiver 34 is provided. The remote transceiver 34 includes a second microphone 38, a second speaker 42 and a door lock switch 46. The doorbell switch 26 provides a signal 50 to the remote transceiver 34 and causes a sound 54 to be produced by the second speaker 42. The remote transceiver 34 provides two-way verbal communication with the entryway mounted transceiver 14. The door lock switch 46 operates the electrical door lock operator 30 from a remote location.

A remote finder 58A, 58B is provided. The remote finder 58A, 58B has a first portion 62 and a second portion 66. The first portion 62 is attached to the remote transceiver 34, has a signal receiver 70 and a notification device 74. The second portion 66 has a signal generator 78. The signal generator 78 is operable by a user 82 from a location 86 remote from the remote transceiver 34. The signal receiver 70 activates the notification device 74 upon receiving a signal 90 from the signal generator 78. When the user 82 operates the signal generator 78, the notification device 74 will inform the user 82 of a location 94 of the remote transceiver 34.

(2) In a variant of the invention, the entryway mounted transceiver 14 and the remote transceiver 34 communicate via radio frequency signals 98.

(3) In another variant, the first portion 62 of the remote finder 58A, 58B responds to acoustical signals 102 and the second portion 66 of the remote finder 58A, 58B produces the acoustical signals 102.

(4) In still another variant, the acoustical signals 102 produced by the second portion 66 of the remote finder 58A, 58B are selected from the group consisting of whistles, bells, buzzers, clicking devices and chimes.

(5) In yet another variant, the first portion 62 of the remote finder 58A, 58B responds to infrared signals 106 and the second portion 66 of the remote finder 58A, 58B produces the infrared signals 106.

(6) In a further variant, the first portion 62 of the remote finder 58A, 58B responds to radio frequency signals 110 and the second portion 66 of the remote finder 58A, 58B produces the radio frequency signals 110.

(7) In still a further variant, the notification device 74 of the first portion 62 of the remote finder 58A, 58B produces an auditory signal 114.

(8) In another variant of the invention, the notification device 74 of the first portion 62 of the remote finder 58A, 58B produces a visual signal 118.

(9) In still another variant, a video camera 122 is provided. The video camera 122 is positioned adjacent an entranceway 126 controlled by the entryway mounted transceiver 14. A video monitor 130 is provided. The monitor 130 is attached to the remote transceiver 34.

The video monitor 130 receives video signals 134 from the video camera 122, thereby permitting the user 82 to view a person 138 seeking entrance at the entranceway 126.

(10) In yet another variant, the video camera 122 is activated by a switch 142 on the remote transceiver 34.

(11) In a further variant, the video camera 122 is activated by the doorbell switch 26 on the entryway mounted transceiver 14.

(12) In still a further variant, a video screen 146 mounted adjacent the entryway mounted transceiver 14 is provided. A video camera 150 is mounted to the remote transceiver 34. The video camera 150 transmits video images 154 visible from the remote transceiver 34. When the remote transceiver 34 is pointed at a user 82, the user 82 and a visitor 138 will have visual communication.

(13) In a final variant of the invention, a switch 158 for the video camera positioned adjacent the entryway mounted transceiver 14 is provided.

The remote intercom operator with finder 10 has been described with reference to particular embodiments. Other modifications and enhancements can be made without departing from the spirit and scope of the claims that follow.

1. A remote intercom operator with finder, comprising:
an entryway mounted transceiver, said transceiver comprising a first microphone, a first speaker, a doorbell switch and an electrical door lock operator;
a remote transceiver, said remote transceiver comprising a second microphone, a second speaker and a door lock switch;
said doorbell switch providing a signal to said remote transceiver and causing a sound to be produced by said second speaker;
said remote transceiver providing two-way verbal communication with said entryway mounted transceiver;
said door lock switch operating said electrical door lock operator from a remote location;
a remote finder, said remote finder having a first portion and a second portion;
said first portion being attached to said remote transceiver, having a signal receiver and a notification device;
said second portion having a signal generator, said signal generator operable by a user from a location remote from said remote transceiver;
said signal receiver activating said notification device upon receiving a signal from said signal generator; and
whereby, when said user operates said signal generator, said notification device will inform said user of a location of said remote transceiver.

2. The remote intercom operator with finder, as described in claim 1, wherein said entryway mounted transceiver and said remote transceiver communicate via radio frequency signals.

3. The remote intercom operator with finder, as described in claim 1, wherein said first portion of said remote finder responds to acoustical signals and said second portion of said remote finder produces said acoustical signals.

4. The remote intercom operator with finder, as described in claim 3, wherein said acoustical signals produced by said second portion of said remote finder are selected from the group consisting of:
whistles, bells, buzzers, clicking devices and chimes.

5. The remote intercom operator with finder, as described in claim 1, wherein said first portion of said remote finder responds to infrared signals and said second portion of said remote finder produces said infrared signals.

6. The remote intercom operator with finder, as described in claim 1, wherein said first portion of said remote finder responds to radio frequency signals and said second portion of said remote finder produces said radio frequency signals.

7. The remote intercom operator with finder, as described in claim 1, wherein said notification device of said first portion of said remote finder produces an auditory signal.

8. The remote intercom operator with finder, as described in claim 1, wherein said notification device of said first portion of said remote finder produces a visual signal.

9. The remote intercom operator with finder, as described in claim 1, further comprising:
a video camera, said video camera positioned adjacent an entranceway controlled by said entryway mounted transceiver;
a video monitor, said monitor attached to said remote transceiver;
said video monitor receiving video signals from said video camera, thereby permitting said user to view a person seeking entrance at said entranceway.

10. The remote intercom operator with finder, as described in claim 7, wherein said video camera is activated by a switch on said remote transceiver.

11. The remote intercom operator with finder, as described in claim 7, wherein said video camera is activated by said doorbell switch on said entryway mounted transceiver.

12. The remote intercom operator with finder, as described in claim 9, further comprising:
a video screen mounted adjacent said entryway mounted transceiver;
a video camera mounted to said remote transceiver, said video camera transmitting video images visible from said remote transceiver; and
whereby, when said remote transceiver is pointed at a user, said user and a visitor will have visual communication.

13. The remote intercom operator with finder, as described in claim 12, further comprising a switch for said video camera positioned adjacent said entryway mounted transceiver.
